(19) United States
(12) Patent Application Publication
(10) Pub. No.: US 2016/0234670 A1
(43) Pub. Date: Aug. 11, 2016

(54) DEVICE-TO-DEVICE SYNCHRONIZATION METHOD AND APPARATUS FOR PARTIAL COVERAGE

(71) Applicant: Nokia Technologies Oy, Espoo (FI)

(72) Inventors: Zhi Zhang, Beijing (CN); Zexian Li, Espoo (CN); Juha Korhonen, Espoo (CN); Kodo Shu, Shanghai (CN); Yixue Lei, Beijing (CN)

(21) Appl. No.: 14/900,313

(22) PCT Filed: Jul. 11, 2013
(86) PCT No.: PCT/CN2013/079225

§ 371 Date: Dec. 21, 2015

(51) Int. Cl. H04W 8/00; H04W 48/10; H04W 56/00; H04W 76/02; H04W 72/04

(52) U.S. Cl. CPC H04W 8/005; H04W 76/023; H04W 72/048; H04W 56/001; H04W 48/10

(57) ABSTRACT

Systems, methods, apparatuses, and computer program products for D2D synchronization in, for example, partial coverage scenarios are provided. One method includes sending, by a network node, information to at least one user equipment in a network. The information may be used by the at least one user equipment to determine whether the at least one user equipment is a full-coverage idle mode user equipment or a downlink-only idle mode user equipment. When, for instance at least one of a pair of device-to-device (D2D) user equipment is outside of the network coverage area, the method includes indicating via a cellular broadcasting message to the downlink-only idle mode and the full-coverage idle mode user equipment to send at least one synchronization signal. The method may then include configuring a RRC_Connected mode user equipment at cell-edge to monitor whether there are user equipment sending synchronization signals.

### BACKGROUND

1. Field

Certain embodiments generally relate to communication systems, and for example, to device-to-device (D2D) communication integrated into a communications network, such as long-term evolution (LTE) or long-term evolution advanced (LTE-A) cellular network specified by the 3rd Generation Partnership Project (3GPP).

2. Description of the Related Art

Two types of communication networks include cellular networks and ad-hoc networks. A cellular network is a radio network made up of one or more cells, where each cell is served by at least one centralized controller, such as a base station (BS), a Node B, or an evolved Node B (eNB). In a cellular network, a user equipment (UE) communicates with another UE via the centralized controller, where the centralized controller relays messages sent by a first UE to a second UE, and visa-versa. In contrast, in an ad-hoc network, a UE directly communicates with another UE, without the need of a centralized controller. Utilizing a cellular network versus an ad-hoc network has its benefits and drawbacks. For example, utilizing a cellular network over an ad-hoc network provides the benefit of easy resource control and interference control. However, utilizing a cellular network over an ad-hoc network also provides the drawback of inefficient resource utilization. For instance, additional resources may be required in a cellular network when the two UEs are close to each other, as compared to an ad-hoc network.

A hybrid network utilizes both a cellular mode and a D2D transmission mode. In a hybrid network, a UE may choose to communicate either via a cellular mode or a D2D transmission mode. As an example, a hybrid network may allow UEs to communicate either via a cellular mode (i.e. via a centralized controller) or via an autonomous D2D transmission mode where the UEs may establish a channel without the need for a centralized controller. The UE may make this selection depending on which mode provides better overall performance. Thus, a hybrid network may improve total system performance over a cellular network or an ad-hoc network. However, in order to utilize a hybrid network, issues related to resource sharing and interference situations may need to be addressed.

In addition, proximity services (ProSe)/D2D discovery and communication is one of the ongoing study items for 3GPP Release 12 (Rel-12) standardization. Among D2D scenarios under study in 3GPP, D2D with out of network coverage and partial coverage is attracting great attention due to the potential public safety applications.

### SUMMARY

One embodiment is directed to a method including sending, by a network node, information to at least one user equipment in a network. The method further includes indicating via a cellular broadcasting message to at least one downlink-only idle mode user equipment and at least one full-coverage idle mode user equipment to send at least one synchronization signal, and configuring a radio resource control connected (RRC_Connected) mode user equipment at cell-edge to monitor whether there are user equipment sending synchronization signals.

Another embodiment is directed to an apparatus. The apparatus includes at least one processor and at least one memory comprising computer program code. The at least one memory and the computer program code are configured, with the at least one processor, to cause the apparatus at least to send information to at least one user equipment in a network. The at least one memory and the computer program code may further be configured, with the at least one processor, to cause the apparatus at least to indicate via a cellular broadcasting message to at least one downlink-only idle mode user equipment and at least one full-coverage idle mode user equipment to send at least one synchronization signal, and to configure a radio resource control connected (RRC_Connected) mode user equipment at cell-edge to monitor whether there are user equipment sending synchronization signals.

Another embodiment is directed to an apparatus including means for sending information to at least one user equipment in a network. The apparatus further includes means for indicating via a cellular broadcasting message to at least one downlink-only idle mode user equipment and at least one full-coverage idle mode user equipment to send at least one synchronization signal, and means for configuring a radio resource control connected (RRC_Connected) mode user equipment at cell-edge to monitor whether there are user equipment sending synchronization signals.

Another embodiment is directed to a method including searching, by a user equipment, for synchronization signals sent by a downlink-only idle mode user equipment having only downlink coverage. The method may then include moving to a radio resource control connected (RRC_connected) mode.

Another embodiment is directed to an apparatus. The apparatus includes at least one processor and at least one memory comprising computer program code. The at least one memory and the computer program code are configured, with the at least one processor, to cause the apparatus at least to search for synchronization signals sent by a downlink-only idle mode user equipment having only downlink coverage, and to move to a radio resource control connected (RRC_connected) mode.

Another embodiment is directed to an apparatus including means for searching for synchronization signals sent by a downlink-only idle mode user equipment having only downlink coverage, and means for moving to a radio resource control connected (RRC_connected) mode.

### BRIEF DESCRIPTION OF THE DRAWINGS

For proper understanding of the invention, reference should be made to the accompanying drawings, wherein:

FIG. 1 illustrates an example of a system according to one embodiment;

FIG. 2a illustrates an example of an RRC_connected mode UE sending a discovery message, according to one embodiment;

FIG. 2b illustrates an example of a DL-only and full coverage idle mode UE sending synchronization signals, according to one embodiment;

FIG. 3a illustrates an example of an apparatus according to an embodiment;

FIG. 3b illustrates an example of an apparatus according to another embodiment;

FIG. 4a illustrates an example of a flow diagram of a method, according to one embodiment; and

FIG. 4b illustrates an example of a flow diagram of a method, according to another embodiment.

### DETAILED DESCRIPTION

It will be readily understood that the components of the invention, as generally described and illustrated in the figures herein, may be arranged and designed in a wide variety of different configurations. Thus, the following detailed description of the embodiments of systems, methods, apparatuses, and computer program products for D2D synchronization in partial coverage scenarios, as represented in the attached figures, is not intended to limit the scope of the invention, but is merely representative of selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention.

Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments. Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

Some embodiments of the invention are applicable to LTE-A, including 3GPP LTE-A Rel-12, which addresses LTE-A supports for network-controlled D2D discovery. The 3GPP has begun carrying out a study for potential services and requirements for D2D communications, referred to as Proximity Services (ProSe). One objective of this study is to look at use cases and identify potential requirements for an operator network controlled discovery and communications between devices that are in proximity, under continuous network control, and/or are under 3GPP network coverage. This could be for the purposes of commercial/social use, network offloading, public safety, and/or integration of current infrastructure services to assure the consistency of the user experience including reachability and mobility aspects.

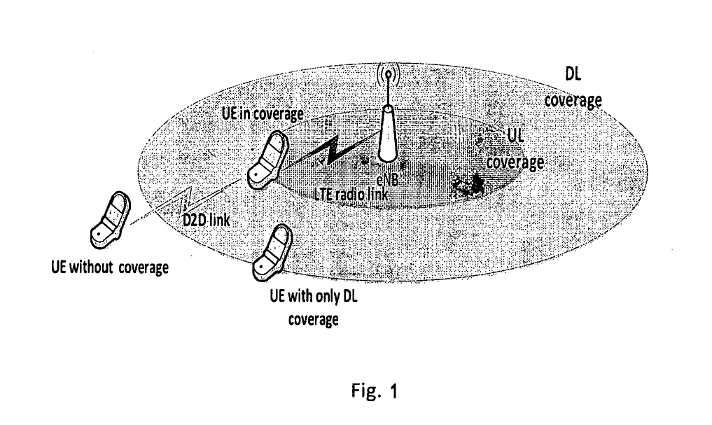

FIG. 1 illustrates an example of a communications system according to one embodiment. In particular, the example of FIG. 1 illustrates a partial coverage scenario where at least one of a pair of D2D UEs is within network coverage and the other D2D UE in the pair is out of network coverage, or the case where there are multiple UEs involved in the same D2D group communication and at least one UE is within network coverage. According to the example of FIG. 1, UE 101 is within the coverage area of eNB 100 and UE 102 is outside the coverage area of eNB 100.

It is noted that when a UE is within the network coverage (e.g., UE 101), it means that this UE may have both uplink (UL) and downlink (DL) communication with eNB. FIG. 1 depicts UL coverage area 105 and DL coverage area 107. In cellular communication, DL coverage 107 is decided by eNB transmit (Tx) capability and UL coverage 105 is decided by UE Tx capability. As a result, for cellular communication, DL coverage is generally larger than UL coverage as illustrated in FIG. 1. UE 103 is an example of a UE with only DL coverage.

The UE 101 in coverage may be in radio resource control idle (RRC_Idle) mode or radio resource control connected (RRC_Connected) mode, while the UEs with only DL coverage are in the RRC_Idle mode. In this disclosure, a distinction is made between the two groups of the Idle mode UEs: the RRC_Idle mode UEs that have only DL coverage (e.g., UE 103) are referred to as DL-only Idle mode UEs, while the RRC_Idle mode UEs with full coverage are referred to as full-coverage Idle mode UEs.

D2D consists of two parts: one is D2D discovery and the other is D2D communication. It is generally assumed that D2D discovery is the prerequisite for D2D communication, although there are special scenario(s) where D2D communication without prior discovery procedure(s) may be possible. Some embodiments of the invention focus on the D2D discovery part.

When D2D discovery and/or communications occurs within network coverage, D2D UE pairs may utilize cellular synchronization signal as the D2D synchronization reference. Accordingly, the UEs may both be synchronized to the cellular DL signal and know when and at what frequency the D2D discovery signals are transmitted relative to, for example, the cellular DL signal. However, for the partial coverage case, it is likely that one UE of the D2D pair is totally out of network coverage and cannot receive any cellular synchronization information. In this case, a problem arises as to how synchronization information should be provided to the D2D UEs in the partial-coverage scenario.

One solution is to enable UEs with network coverage to send a synchronization signal as the reference to UEs without network coverage. However, considering the UL and DL coverage gap illustrated in FIG. 1, there is opportunity to further optimize such a solution in a more power efficient manner.

Embodiments of the invention take into account that the type of the transmitted D2D discovery signal may depend on the UE state (e.g., RRC_Idle/RRC_Connected mode, full network coverage/only DL coverage), location of a RRC connected mode UE in the cell, or the type of discovery signals observed. Herein, the type of the discovery signal may mean the structure of the signal (bare synchronization signal/discovery message/both synchronization signal and discovery message) and/or selection of the synchronization signal sequence or radio resource.

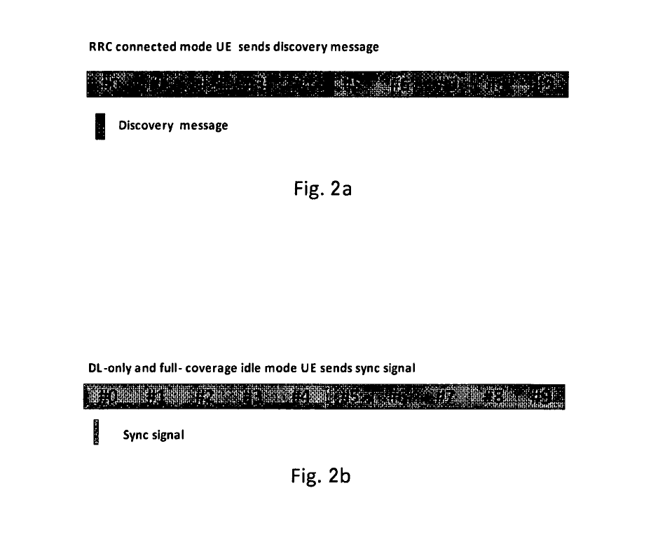

According to one embodiment, in a partial coverage case, the eNB may indicate to DL-only idle mode UEs and full-coverage idle mode UEs to send synchronization signal(s). In one example, the eNB indication to the DL-only idle mode UEs and full-coverage idle mode UEs is done via a cellular broadcasting message, such as a system information block (SIB). In an embodiment, the eNB may further configure different synchronization signal to be sent from full-coverage idle mode UE and DL-only idle mode UEs, respectively. FIG. 2b illustrates an example of a DL-only and full coverage idle mode UE sending synchronization signals, according to one embodiment.

According to an embodiment, the eNB may configure RRC_connected mode UE(s) at the cell-edge to monitor whether there are UEs to send synchronization signal(s). It is noted that the synchronization signal sent by the UE is distinguished from the synchronization signal sent by the eNB, e.g., they are sent at different time-frequency resources.

A connected mode UE may distinguish DL-only idle mode UEs from full-coverage idle mode UEs, for example, through the difference in synchronization signals. Then, in one embodiment, the connected mode UE may set up D2D link establishment between the RRC connected mode UE and DL-only idle mode UEs, where the RRC connected mode UE may act as a relay station.

In addition, according to an embodiment, the eNB may configure the RRC_connected mode UE at the cell edge to only send discovery message for D2D discovery purpose, if there are synchronization signals detected. FIG. 2a illustrates an example of an RRC_connected mode UE only sending a discovery message, while idle mode UEs with DL-only or full coverage are sending synchronization signals, according to one embodiment.

The full-coverage idle mode UEs may be configured by specification, broadcast signaling, or user setting to search for synchronization signals that are sent by DL-only idle mode UEs. Detection of such synchronization signals may trigger a procedure resulting in the full-coverage idle mode UE moving to RRC_Connected mode and serving as a relay between the DL-only idle mode UE and eNB. It is noted that the discovery sequence may also be used for synchronization and, therefore, may have the same function as a synchronization signal. For the sake of simplicity, the term “synchronization signal” is used generally in this disclosure.

As mentioned above, in one embodiment, the eNB may indicate to DL-only idle mode UEs and full-coverage idle mode UEs to send synchronization signal(s) in the partial network coverage scenario. It should be noted that, as used herein, “DL-only” means that the UE can get DL synchronization information from the cellular network and decode cellular broadcasting message, but that the UE cannot get UL access to the system. The broadcasting information may include a SIB (system information block) where the eNB instructs these UEs on discovery signal transmission. An instruction may be that such UEs should send synchronization signals. The instructions may also include some information about the synchronization signal, such as sequence and radio resources used for synchronization signal transmission. It is also possible that the sequence and corresponding resource information is specified in a pre-determined way.

In one embodiment, the SIB may also include information that an RRC_Idle mode UE may use for deciding if it also has UL coverage, i.e., whether it is a DL-only or a full-coverage idle mode UE. A threshold for the received DL signal strength may be given such that, if the received DL signal is above the threshold, the UE may assume that it will also have UL coverage, and it may then send a specific type of discovery signal (i.e., a discovery signal that implicitly indicates the UE has both DL and UL coverage). When the DL signal strength received by the UE is below the threshold, it may send a different type of discovery signal to implicitly indicate that it has DL coverage only. Such a different discovery signal will help other detecting UEs to know that the discovery signals are from a DL-only or from a full-coverage idle mode UE.

In an embodiment, a full-coverage idle mode UE may become a relay node between DL-only coverage idle mode UEs and the eNB. According to an example procedure, a full-coverage idle mode UE finds a synchronization signal of a DL-only idle mode UE that has been sent in order to get a relayed network connection. The full-coverage idle mode UE then moves to the RRC_Connected mode. Once in the RRC_Connected mode, the full-coverage idle mode UE performs the same actions as RRC_Connected mode UEs in order to start relaying.

As mentioned above, according to an embodiment, the eNB may configure RRC_connected mode UE(s) at the cell-edge to monitor whether there are UEs to send synchronization signal(s). For a RRC_Connected mode UE, the eNB may judge whether this UE is in cell edge or not from, for example, cellular UL measurement(s), such as through SRS or power headroom reporting (PHR), or timing advance setting. After identifying the cell edge UEs with support for D2D, the eNB may configure such UEs to monitor synchronization signals. The UE may measure the signal strength based on a given sequence and resource. A first option is for the UE to report the measurement results to the eNB and let the eNB decide if there are such signals nearby. In a second option, the eNB may configure a threshold to the UE and let the UE itself decide if there are signals nearby. For this second option, if there is a nearby synchronization signal, the UE may only send a discovery message for D2D discovery; if there is no nearby synchronization signal, the UE may send a synchronization signal (or discovery sequence) and discovery message for D2D discovery.

As described above, a RRC_Connected mode UE may distinguish the DL-only and full-coverage Idle mode UEs through the difference in synchronization signals. According to certain embodiments, there may be different discovery procedures when UEs in RRC_Connected mode detect UEs in DL-only or full-coverage idle mode UEs. An example is the different need of relaying when UEs want a network connection. The full-coverage idle mode UEs may send a RRC connection request message directly to the eNB, i.e., they never need to be discovered for relaying by the RRC_Connected mode UEs. However, DL-only idle mode UEs cannot communicate directly with the eNB. Therefore, a typical reason for a DL-only idle mode UE to be discovered is the desire to be relayed by a RRC_Connected mode UE.

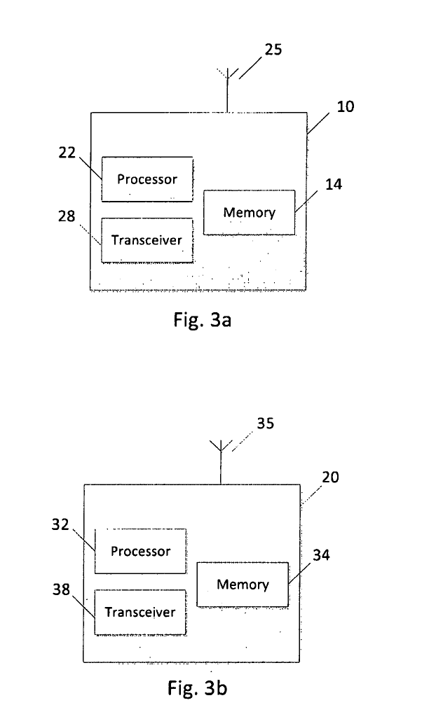

FIG. 3a illustrates an example of an apparatus 10 according to an embodiment. In one embodiment, apparatus 10 may be a network node, such as a base station or eNB. For instance, apparatus 10 may be a eNB 100 as illustrated in FIG. 1 discussed above. However, it should be understood that apparatus 10 may take other forms and the device illustrated in FIG. 1 is merely one example. Further, it should be noted that one of ordinary skill in the art would understand that apparatus 10 may include components or features not shown in FIG. 3a. Only those components or features necessary for illustration of the invention are depicted in FIG. 3a.

As illustrated in FIG. 3a, apparatus 10 includes a processor 22 for processing information and executing instructions or operations. Processor 22 may be any type of general or specific purpose processor. While a single processor 22 is shown in FIG. 3a, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 further includes a memory 14, which may be coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 may be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

Apparatus 10 may also include one or more antennas 25 for transmitting and receiving signals and/or data to and from apparatus 10. Apparatus 10 may further include a transceiver 28 configured to transmit and receive information. For instance, transceiver 28 may be configured to modulate information on to a carrier waveform for transmission by the antenna(s) 25 and demodulate information received via the antenna(s) 25 for further processing by other elements of apparatus 10. In other embodiments, transceiver 28 may be capable of transmitting and receiving signals or data directly.

Processor 22 may perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 stores software modules that provide functionality when executed by processor 22. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to one embodiment, apparatus 10 may be a network node, such as a base station or eNB. In this embodiment, apparatus 10 may be controlled by memory 14 and processor 22 to send information to at least one user equipment in a network. In one embodiment, the at least one user equipment may be a radio resource control idle (RRC_Idle) mode user equipment. According to an embodiment, the information may be used by the at least one user equipment to determine whether the at least one user equipment is a full-coverage idle mode user equipment having uplink coverage or a downlink-only idle mode user equipment having only downlink coverage.

When at least one of a pair of device-to-device (D2D) user equipment is outside of the network coverage area, apparatus 10 may be controlled by memory 14 and processor 22 to indicate via a cellular broadcasting message, such as a SIB, to the downlink-only idle mode user equipment and the full-coverage idle mode user equipment to send at least one synchronization signal. In an embodiment, apparatus 10 may be further controlled by memory 14 and processor 22 to configure a radio resource control connected (RRC_Connected) mode user equipment at cell-edge to monitor or detect whether there are user equipment sending synchronization signals.

According to one embodiment, apparatus 10 may also be controlled by memory 14 and processor 22 to send the information comprising a threshold for received downlink signal strength, and, when the received downlink signal strength of the at least one user equipment is higher than the threshold, the at least one user equipment determines that it has uplink coverage.

Additionally, in one embodiment, apparatus 10 may also be controlled by memory 14 and processor 22 to configure different synchronization signals to be sent from the downlink-only idle mode user equipment and the full-coverage idle mode user equipment, respectively. According to certain embodiments, apparatus 10 may be controlled by memory 14 and processor 22 to configure the radio resource control connected (RRC_Connected) mode user equipment by configuring the radio resource control connected (RRC_Connected) mode user equipment at the cell-edge to send at least one discovery message for device-to-device (D2D) discovery purposes when synchronization signals are detected.

FIG. 3b illustrates an example of an apparatus 20 according to another embodiment. In an embodiment, apparatus 20 may be a user equipment in a communications network, such as the UEs illustrated in FIG. 1 discussed above. It should be noted that one of ordinary skill in the art would understand that apparatus 20 may include components or features not shown in FIG. 3b. Only those components or features necessary for illustration of the invention are depicted in FIG. 3b.

As illustrated in FIG. 3b, apparatus 20 includes a processor 32 for processing information and executing instructions or operations. Processor 32 may be any type of general or specific purpose processor. While a single processor 32 is shown in FIG. 3b, multiple processors may be utilized according to other embodiments. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 20 further includes a memory 34, which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 34 may be comprised of any combination of random access memory (RAM), read only memory (ROM), static storage such as a magnetic or optical disk, or any other type of non-transitory machine or computer readable media. The instructions stored in memory 34 may include program instructions or computer program code that, when executed by processor 32, enable the apparatus 20 to perform tasks as described herein.

Apparatus 20 may also include one or more antennas 35 for transmitting and receiving signals and/or data to and from apparatus 20. Apparatus 20 may further include a transceiver 38 configured to transmit and receive information. For instance, transceiver 38 may be configured to modulate information on to a carrier waveform for transmission by the antenna(s) 35 and demodulate information received via the antenna(s) 35 for further processing by other elements of apparatus 20. In other embodiments, transceiver 38 may be capable of transmitting and receiving signals or data directly.

Processor 32 may perform functions associated with the operation of apparatus 20 including, without limitation, precoding of antenna gain/phase parameters, encoding and decoding of individual bits forming a communication message, formatting of information, and overall control of the apparatus 20, including processes related to management of communication resources.

In an embodiment, memory 34 stores software modules that provide functionality when executed by processor 32. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

As mentioned above, according to one embodiment, apparatus 20 may be a user equipment, such as the full-coverage idle mode user equipment discussed above. In this embodiment, apparatus 20 may be controlled by memory 34 and processor 32 to search for or detect synchronization signals sent by a downlink-only idle mode user equipment having only downlink coverage, and to move to a radio resource control connected (RRC_connected) mode. Additionally, in an embodiment, apparatus 20 may be further controlled by memory 34 and processor 32 to serve as a relay between the downlink-only idle mode user equipment and an evolved node B (eNB). In one example, apparatus 20 is controlled to serve as a relay between the downlink-only idle mode user equipment and the evolved node B (eNB) when the synchronization signals sent by the downlink-only idle mode user equipment are detected.

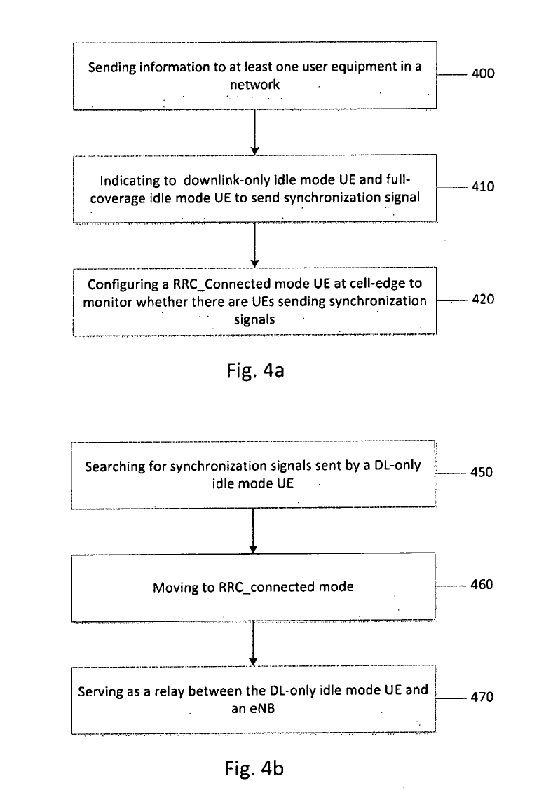

FIG. 4a illustrates an example of a flow chart of a method for D2D synchronization in, for example, partial coverage scenarios. In one example, the method of FIG. 4a may be performed by a network node, such as an eNB. The method may include, at 400, sending information to at least one user equipment in a network. The at least one user equipment may be a radio resource control idle (RRC_Idle) mode user equipment. The information may be used by the at least one user equipment to determine whether the at least one user equipment is a full-coverage idle mode user equipment having uplink coverage or a downlink-only idle mode user equipment having only downlink coverage. The sending of the information may further include sending information including a threshold for received downlink signal strength, and, when the received downlink signal strength of the at least one user equipment is higher than the threshold, the at least one user equipment determines that it has uplink coverage.

The method may also include, at 410, when at least one of a pair of device-to-device (D2D) user equipment is outside of the network coverage area, indicating via a cellular broadcasting message, such as a SIB, to the downlink-only idle mode user equipment and the full-coverage idle mode user equipment to send at least one synchronization signal. The method may then include, at 420, configuring a radio resource control connected (RRC_Connected) mode user equipment at cell-edge to monitor whether there are user equipment sending synchronization signals. The configuring of the radio resource control connected (RRC_Connected) mode user equipment may include configuring the radio resource control connected (RRC_Connected) mode user equipment at the cell-edge to send at least one discovery message for device-to-device (D2D) discovery purposes when synchronization signals are detected. In some embodiments, the method may further include configuring different synchronization signals to be sent from the downlink-only idle mode user equipment and the full-coverage idle mode user equipment, respectively.

FIG. 4b illustrates an example of a flow chart of a method for D2D synchronization in, for example, partial coverage scenarios. In one example, the method of FIG. 4b may be performed by a UE, such as a full-coverage idle mode user equipment. The method may include, at 450, searching for synchronization signals sent by a downlink-only idle mode user equipment having only downlink coverage. The method may then include, at 460, moving to a radio resource control connected (RRC_connected) mode. In one embodiment, the method may include, at 470, serving as a relay between the downlink-only idle mode user equipment and an evolved node B (eNB). In one embodiment, the serving includes serving as the relay between the downlink-only idle mode user equipment and the evolved node B (eNB) when the synchronization signals sent by the downlink-only idle mode user equipment are detected.

In some embodiments, the functionality of any of the methods described herein, such as those illustrated in FIGS. 4a and 4b discussed above, may be implemented by software and/or computer program code stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software. In another embodiment, an apparatus is disclosed comprising means to perform any of the described methods.

In view of the above, embodiments of the invention may provide several advantages. For example, some advantages include further optimizing the D2D discovery for the partial coverage case by identifying full-coverage idle mode UEs and DL-only idle mode UEs. For the RRC connected mode UEs, since synchronization signals may be saved, it is more power efficient.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1-25. (canceled)

26. A method, comprising:
sending, by a network node, information to at least one user equipment in a network;
indicating via a cellular broadcasting message to at least one downlink-only idle mode user equipment having only downlink coverage and/or at least one full-coverage idle mode user equipment having uplink coverage at cell-edge to send at least one synchronization signal; and
configuring a radio resource control connected (RRC_Connected) mode user equipment at cell-edge to monitor whether there are user equipment sending synchronization signals.

27. The method according to claim 26, wherein the information is used by the at least one user equipment to determine whether the at least one user equipment is a full-coverage idle mode user equipment or a downlink-only idle mode user equipment.

28. The method according to claim 26, wherein the sending of the information comprises sending information comprising a threshold for received downlink signal strength wherein the threshold for determining that the at least one user equipment has downlink-only idle mode coverage when the received downlink signal strength of the at least one user equipment is lower than the threshold and further for determining that the at least one user equipment has full-coverage when the received downlink signal strength of the at least one user equipment is higher than the threshold.

29. The method according to claim 26, further comprising configuring different synchronization signals to be sent from the downlink-only idle mode user equipment and the full-coverage idle mode user equipment, respectively.

30. The method according to claim 26, wherein the configuring of the radio resource control connected (RRC_Connected) mode user equipment comprises configuring the radio resource control connected (RRC_Connected) mode user equipment at the cell-edge to send at least one discovery message for device-to-device (D2D) discovery purposes when synchronization signals are detected.

31. The method according to claim 26, wherein the at least one user equipment comprises a radio resource control idle (RRC_Idle) mode user equipment.

32. An apparatus, comprising:
at least one processor; and
at least one memory comprising computer program code,
the at least one memory and the computer program code configured, with the at least one processor, to cause the apparatus at least to
send information to at least one user equipment in a network;
indicate via a cellular broadcasting message to at least one downlink-only idle mode user equipment having only downlink coverage and/or at least one full-coverage idle mode user equipment having uplink coverage at cell-edge to send at least one synchronization signal; and
configure a radio resource control connected (RRC_Connected) mode user equipment at cell-edge to monitor whether there are user equipment sending synchronization signals.

33. The apparatus according to claim 32, wherein the information is used by the at least one user equipment to determine whether the at least one user equipment is a full-coverage idle mode user equipment or a downlink-only idle mode user equipment.

34. The apparatus according to claim 32, wherein the at least one memory and the computer program code are further configured, with the at least one processor, to cause the apparatus at least to send the information comprising a threshold for received downlink signal strength
wherein the threshold for determining that the at least one user equipment has downlink-only idle mode coverage when the received downlink signal strength of the at least one user equipment is lower than the threshold and further for determining that the at least one user equipment has full-coverage when the received downlink signal strength of the at least one user equipment is higher than the threshold.

35. The apparatus according to claim 32, wherein the at least one memory and the computer program code are further configured, with the at least one processor, to cause the apparatus at least to configure different synchronization signals to be sent from the downlink-only idle mode user equipment and the full-coverage idle mode user equipment, respectively.

36. The apparatus according to claim 32, wherein the at least one memory and the computer program code are further configured, with the at least one processor, to cause the apparatus at least to configure the radio resource control connected (RRC_Connected) mode user equipment by configuring the radio resource control connected (RRC_Connected) mode user equipment at the cell-edge to send at least one discovery message for device-to-device (D2D) discovery purposes when synchronization signals are detected.

37. The apparatus according to claim 32, wherein the at least one user equipment comprises a radio resource control idle (RRC_Idle) mode user equipment.

38. The apparatus according to claim 32, wherein the apparatus comprises a base station.

39. A method, comprising:
searching, by a user equipment having full-coverage idle mode, for synchronization signals sent by a downlink-only idle mode user equipment having only downlink coverage; and
moving to a radio resource control connected (RRC_connected) mode.

40. The method according to claim 39, further comprising serving as a relay between the downlink-only idle mode user equipment and a base station.

41. The method according to claim 39, further comprising:
determining that the user equipment has downlink-only idle mode coverage when a received downlink signal strength of the user equipment is lower than a threshold and that the user equipment has full-coverage idle mode when the received downlink signal strength of the user equipment is higher than the threshold; and
transmitting different synchronization signals based at least on the determining.

42. An apparatus, comprising:
at least one processor; and
at least one memory comprising computer program code,
the at least one memory and the computer program code configured, with the at least one processor, to cause the apparatus at least to
search for synchronization signals sent by a downlink-only idle mode user equipment having only downlink coverage; and
move to a radio resource control connected (RRC_connected) mode.

43. The apparatus according to claim 42, wherein the apparatus comprises a full-coverage idle mode user equipment.

44. The apparatus according to claim 42, wherein the at least one memory and the computer program code are further configured, with the at least one processor, to cause the apparatus at least to serve as a relay between the downlink-only idle mode user equipment and a base station.

45. The apparatus according to claim 44, wherein the at least one memory and the computer program code are further configured, with the at least one processor, to cause the apparatus at least to serve as the relay between the downlink-only idle mode user equipment and the base station when the synchronization signals sent by the downlink-only idle mode user equipment are detected.
